(19) United States
(12) Patent Application Publication
(10) Pub. No.: US 2003/0115296 A1
(43) Pub. Date: Jun. 19, 2003

(54) Method for improved host context access in storage-array-centric storage management interface

(76) Inventors: Ray M. Jantz, Wichita, KS (US); Scott Hubbard, Wichita, KS (US)

Correspondence Address: LSI LOGIC CORPORATION, 1621 BARBER LANE, MS D-106, LEGAL DEPARTMENT, MILPITAS, CA, 95035, US

(21) Appl. No.: 10/023,379

(22) Filed: Dec. 17, 2001

(51) Int. Cl. G06F 15/177

(52) U.S. Cl. 709/220; 709/223

(57) ABSTRACT

A storage array contains firmware which maintains topology and other information in a computer system. Individual host computers each have a host context agent which interfaces with both thin client devices and the storage array. A user by a simple GUI command or set of commands may update and/or retrieve topology and other computer system configuration information which is stored by either a host computer or the storage array or both.

### FIELD OF THE INVENTION

The present invention generally relates to the field of computer storage management, and particularly to a method in which a thin client accesses a host computer's context information in a storage-array-centric system.

### BACKGROUND OF THE INVENTION

A thin client architecture is a form of client/server architecture in which no data is stored and relatively little processing occurs on the thin client device. The thin client accesses a server, in this case a pair of redundant RAID controllers, for most, if not all, of its functions to provide users with an inexpensive interface device. The thin client device connects to the server through the network to process applications, access files, print, and perform services.

Storage area networks (SAN) are gigabit-rate networks that allow high throughput, long distance communication distances, and versatile connectivity between servers and storage devices. They link computers on a network, storage devices (e.g., disk arrays), and bridges and multiplexers, all connected to Fibre Channel switches. The linked computers may be servers that store resources, run applications, host web pages, support printing, or provide other services. SANs offer good performance, reliability, scalability, fault recovery, and diagnostic information and scalability of the critical link between servers and storage devices.

A common feature of storage arrays is the ability to map an array volume to a group of host ports, so that this group and only this group can see and access the volume. There is, however, a mismatch between the array view of the port topology and the user's preferred view of that topology: the array deals with a flat space of host ports, whereas the user prefers to think of port groupings that map one-to-one onto individual host computers, or, in some cases, clusters of host computers.

Because of the user's extra knowledge of the topology layout, his inclination is to map volumes to hosts, not individual ports. Since the actual mapping procedures are in the array firmware, the only way of accomplishing the topology definition today is through a tedious manual process. (Mapping refers to the relation of a volume on the storage array to a logical unit number (LUN) of a particular host.) The system administrator must first determine the world-wide names for each host port and then associate these host ports to each host connected to the array. Once this is done, the administrator must manually enter the host type (e.g., UNIX, Windows, Windows cluster member, etc.) for each host, because the array may need to behave differently depending on the host type. As the topologies become larger and more complex, entering this information becomes more time consuming and error prone. Clearly there is a need to automate the process of “topology acquisition” by the array.

Another situation where usability can be substantially improved by greater access to “host context” information is the case of identifying operating system devices in the thin client interface. The thin client presents storage-array-centric volume identification information, which is not sufficient for a system administrator to manage storage in the context of a particular host. The system administrator prefers to identify volumes by the name that the host operating system assigned to it, since this will be the name that the operating system (OS) and applications will use in the reporting of exceptional conditions requiring the administrator's attention. The thin client needs a way to interrogate hosts on the storage area network (SAN) and determine what device names the OS has assigned to volumes mapped to the hosts.

The problem posed by a storage management architecture that relies on a thin graphical client communicating with a set of network accessed storage arrays that have the storage management “business logic” embedded in the firmware is that the thinner the client, the less knowledge it has about the host environment, which can substantially reduce opportunities for enhanced usability. The problem is aggravated by the thin client being able to run on any suitable computer on the network; it therefore does not readily have access to information and control for the other hosts on the network.

Therefore, it would be desirable to provide a method and apparatus for accessing host context information from a host connected to the storage array and displaying the host context information on a thin client.

### SUMMARY OF THE INVENTION

Accordingly, the present invention is directed to a method and apparatus for providing host context information on a user interface displayed on a thin client device in an environment consisting of at least one storage array connected to multiple host computers.

In a first aspect of the present invention, a computer system has a thin client, a host context agent, and a storage array. The storage array and the host context agent provide information to the thin client to be displayed on a graphical user interface of the thin client.

In a second aspect of the present invention, a computer program of instructions provides instructions for the steps of generating and sending a command for a host context information to a host computer having the host context information and generating and second a command to a storage array for host context information in certain applications.

In a third aspect of the present invention, a method for host context access in storage array centric storage management interface, includes the method of making a request for host context data on a thin client, generating and transmitting a “provide first host context data” command to multiple host computers in an information request and generating and transmitting a “provide second host context” data command to a storage array in an information request.

The invention solves a problem found in storage management architecture that relies on a thin graphical client communicating with a set of network accessed storage arrays that have the storage management “business logic” (the code that implements the rules for business processes; specifically, the rules for managing a storage array) embedded in the firmware. (Such an architecture would be deployed in order to reduce the host based software content of a storage array total solution, thereby improving time-to-market through a reduction in software porting efforts.)

The main new feature of this invention is the means for providing access to host context information and control to a thin client that otherwise would not have such information. In addition to the basic infrastructure that provides the host context agent framework, principal features that could be implemented as plug-ins include storage array topology and host type acquisition and OS name-to-array-volume-name correlation.

The main advantage of this invention is the increased product usability that can be attained when the thin client has access to host context information and control.

The host context agent of the present invention has a framework for executing code on its corresponding host computer in which context information is pushed onto the storage arrays and pulled out to the thin client device requesting it, an interface for plug ins, and plug in functionality. The point of such architecture is to allow easy extension of the host context agent as new needs arise.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates a relational block diagram of two host computers' ports connected to a storage array of the present invention;

FIG. 2 illustrates a relational block diagram of an embodiment of the present invention showing the interrelationship of the thin client, host computers, and storage array; and

FIG. 3 illustrates a functional block diagram of topology acquisition through a thin client of the present invention.

### DETAILED DESCRIPTION OF THE INVENTION

Reference will now be made in detail to the presently preferred embodiments of the invention, examples of which are illustrated in the accompanying drawings.

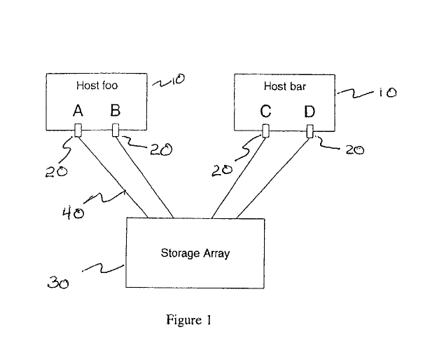

Referring generally now to FIGS. 1 through 3, exemplary embodiments of the present invention are shown.

FIG. 1 illustrates a relational block diagram of two host computers' ports connected to a storage array of the present invention. Two host computers 10, host computer foo and host computer bar, each have two ports 20A and B or C and D which are connected by a suitable connecting means 40 such as cable or wireless communication to a storage array 30 which consists of one or more volumes for data storage.

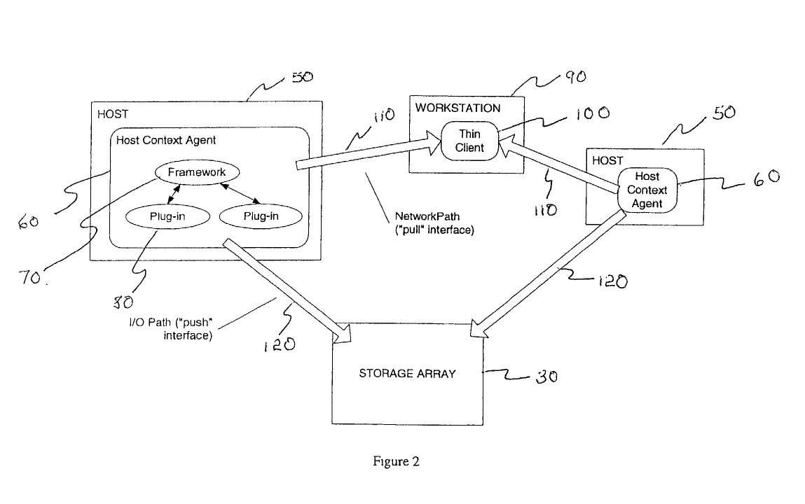

FIG. 2 illustrates a relational block diagram of an embodiment of the present invention showing the interrelationship of the thin client, host computers, and storage array.

Each host computer 50 is connected to both the storage array 30 and a work station 90. On the work station 90 is a thin client 100. The thin client 100 pulls data 110 from the host computer 50. This data is stored at the host computer 50, is pushed to the storage array, and is then retrieved from the storage array 30 by the work station.

Each host computer 50 has a host context agent 60. The host context agent has three features: 1) a framework 70 for executing code on each of the host computers 50 in a SAN where such code can both “push” context information (the topology and host type information) to the storage arrays, and also allow context information to be “pulled” out of the hosts by the thin client; 2) an interface for plugging in host-dependent functions for information-gathering and control on the host where the framework is running; and 3) plug-in 80 functionality. This architecture allows easy extension of the host context agent as new needs arise.

A graphical user interface (GUI) may be provided on the thin client 110. The host context agent may provide an interface for obtaining the OS device name of a volume, given its volume world-wide name. The host context agent interface for obtaining the OS device name may be a Remote Procedure Call, getSystemDeviceName. The GUI may provide an appropriate interface for getting and viewing the information available via getSystemDeviceNames.

The OS device name of a volume may be reported on the GUI from information obtained from the host context agent as a volume property when the volume is being viewed under the storage partitions/mappings view. (This type of interface assures that the system device name will be explicitly requested every time the user wants to see it, avoiding the possibility of it sometimes being stale.)

The host context agent consisting of a framework program resident on the host computer and plug-ins assists in certain controller and GUI operations that require host context and resides on a host computer. A framework is software designed for easily extending functionality. Host and server are terms which here may be used synonymously. An agent is a program to perform standard functions autonomously, commonly used for data transfers. A plug-in is a locally stored helper program that expands the main program's capabilities. The controller, the storage controller which is part of the SAN, and thin client may have greater access to context information for the host to which the array is attached, in order to increase overall solution usability. The host context agent may be implemented as an RPC server running on the host where the array is attached. The client may be an RPC client of the host context agent. The host context agent may be dependent on the existence of at least one logical unit number (LUN), for communication with the array. The host context agent may be implemented so that its set of services may be readily expanded. The host context agent may acquire the information to be pushed by either of, or a combination of, two methods: a) automatically, via calls on the OS, or b) by the user supplying this information to the host context agent. The GUI may allow the user to override the host name, cluster name, and host type setting that were “pushed” by the host.

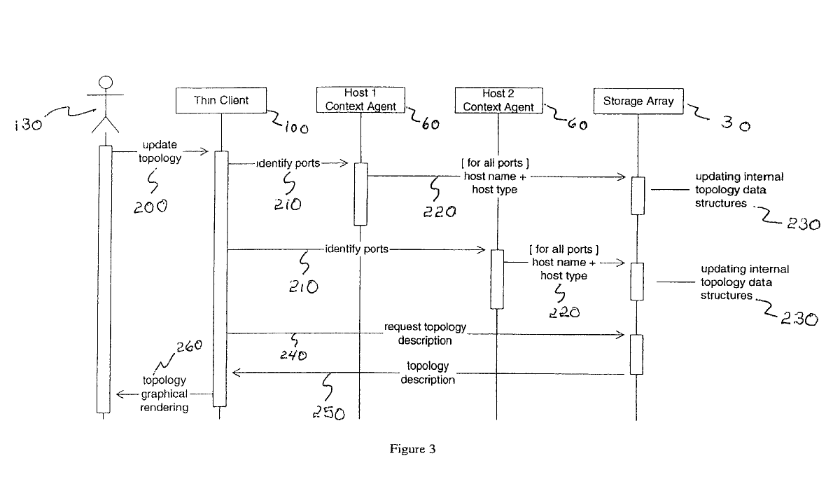

FIG. 3 illustrates a sequence diagram which describes the dynamic workings of the host context agent. Although the diagram shows the actions of the two host computers 60 (Host 1 and Host 2) being done in series, in actual practice it would be more efficient to do them in parallel.

Topology acquisition by the thin client is one feature of the present invention. The host context agent automates the acquisition of host topology information. In an embodiment, the host computer pushes its local topology acquisition to the controller over all in-band I/O paths to the storage array. Topology information may include a) host name, b) host type, c) cluster name, d) host internet protocol (IP) address, e) port number of the host context agent, and/ or other information. The host IP address may be available as a host property in the GUI. To support the host computer's ability to push topology information to the array, the controller may provide an in-band small computer system interface (SCSI) command, called SET TOPOLOGY (or similar command or instruction). This may be provided as a sub-function of a higher-level command such as MODE SELECT or SEND DIAGNOSTIC. If the information acquired via SET TOPOLOGY indicates a change in topology, the array may reflect a new configuration and emit a “config change” notification.

Also, the method of pushing topology information to the array may be by supplying host identification information to the controller out all ports from the host to the array. The host identification information may include the host type and host name. With this information, the storage array may be programmed to treat all ports for which the pushed information contains the name of the same host as part of that host. In the case of the thin client wanting host context information, there would be no interaction between host context agent and the storage array; the agent would just gather the requested information from the host and return it to the thin client.

Refreshing the topology information may be done periodically and/or on the command of the user. Topology information may be refreshed automatically when the host context agent starts. Automatic topology refresh may be performed by the host context agent at regular timer-driven intervals. The user may set the topology refresh period via the GUI. It may be possible for the user to disable or enable the timer-driven topology refresh from the GUI. The host context agent may support RPC calls such as disableRegularTopologyRefresh and enableRegularTopologyRefresh. Refresh of topology information may be initiated under the GUI interface. The interface may provide for refreshing topology for all hosts attached to the array, for a cluster of hosts, or for an individual host. The refresh of host topology from the GUI may be accomplished via a refreshTopology RPC call. Appropriate measures may be in place for resolving conflicts between old and new topologies. The user may be presented with adequate information and GUI interfaces to manually manage the conflict resolution if desired. Topology changes from the host context agent may be accepted immediately by the controller and reflected in the current configuration, but “stale” topology may still be recoverable. The auto-acquired topology may be presented to the client via the application programming interface (API) call, the same as manually entered topology would be. Manual input of the topology through the GUI may continue to be supported. The topology information, whether auto- or manually-acquired may be presented by the GUI.

Changes are expected to occur to a topology. Newly discovered topology objects may be automatically added. A newly discovered association of a new object to an existing object may be automatically created. A newly discovered association of a new object to another new object may be automatically created. A change that associates an existing object “A” with a different object may automatically take effect; however, the old association may not be deleted, and a “ghost” of object “A” may be left behind as a participant in the old association. The mappings of a “ghost” object are remembered, but are inactive. Topology objects that were once, but are no longer, reported to the storage array controller by the host context agent may not be automatically deleted. “Stale” topology objects or “ghost” objects may be deleted from the GUI by performing an explicit “remove” operation.

In FIG. 3, a user 130 initiates, via a user interface such as a graphical user interface on a thin client device 100, a command 200 to update topology. This command causes the thin client 100 to send commands to each and every host computer's host context agent 60 and the storage array 30. The host context agents 60 are instructed to identify ports 210. After this completes, the storage array is instructed to provide a topology description 240. The host context agents 60, in turn, provide the storage array 30 with the host name and the host type 220. The storage array 30 updates the internal topology data structure 230. The storage array 30 provides a topology description to the thin client 250. The thin client generates a readable graphical rendering 260 on a display screen for the user 130.

An embodiment implementing the present invention may have the host context agent framework be RPC code residing on the host computer and the plug-ins be RPC procedures. By doing so, the interaction between the thin client and the various hosts is straightforward and nearly transparent to the network messaging that occurs.

Another implementation consideration is the choice of programming language. In one embodiment, Java may be used to the greatest extent possible and other programming may be done using C code. Other programming languages may additionally be used.

The invention need not rely on Remote Procedure Call as the framework. An equally viable solution of another embodiment is to use Java's Remote Method Invocation as the method for thin-client-to-host communication. Using Java's Remote Method Invocation would probably reduce the use of other programming code, such as C code.

Still another approach may be for the implementation to have its own private communication mechanism.

There are other uses of the present invention besides automation of topology and host type acquisition by the storage array and providing the means for the thin client to determine the host names that have been assigned to the array volumes. These other uses may include host cluster membership and mappings, device registration, management of services, and device scanning.

The topology information that is pushed to the array may include host cluster membership. Doing so supports a multi-tiered topology where hosts themselves can be grouped into higher-level collections that represent clusters. An API supplied by the cluster software may be used to determined cluster membership, or entries for specifying host name, host type, and cluster name may be made. If host name is not specified, host name may be the network hostname; if cluster name is not specified, the cluster for this host may be set to a generic type. Grouping by host cluster allows the mapping of a volume to a cluster of hosts that would then all have access to the same data. This represents the typical cluster manager configuration where host computer failures are recovered via host-level failover with uninterrupted access to the same data as the failed host. Newly discovered host-to-cluster relationships may cause the host to inherit the mappings of the cluster. A means of transferring mappings and any important attributes from one object to another may be provided. Newly discovered host-bus-adapter (HBA)-to-host relationships may cause the HBA to inherit the mappings of the host.

The thin client may be configured to present a “device registration” interface. A common feature of storage array environments is dynamic volume creation. A problem with this is that the host must be explicitly told to register the new volume so the user can have access to it through the host OS. The host context agent may supply an interface to perform this registration on the host where it is running, and the thin client may invoke this interface after a new volume has been created for that host. The device registration interface presented by the host context agent may be an RPC call, scanForDevices. ScanForDevices may invoke a system dependent procedure for scanning and registering devices visible to that host. In the event that device scanning is not available on a particular host, scanForDevices may so indicate via a return status. The scanForDevices call may be made from a separate Java thread so as to allow continued availability of the interface for other tasks. In the GUI, the user may be able to initiate a device scan for all hosts, for all hosts in a cluster, or for an individual host. The user interface may indicate 1) that a device scan is running for a particular host and 2) when a device scan completes. There is no requirement to indicate device scan progress.

Management of array-related services may be performed by software run on the host computers. Another common feature of storage array solutions is to have services such as monitor programs running on at least one host. A monitor periodically checks for any exceptional conditions on the array. Such conditions are reported to the system administrator via SNMP (Simple Network Management Protocol, a protocol by which network-attached devices can be queried and configured by other network-attached SNMP client systems), e mail, or paging. Presently all management of such services (e.g., starting and stopping) must be done on the host where the host is running. By having a host context agent running on the same machines as the service, it would be possible for the thin client to communicate with the host context agent for the purpose of managing the service from the thin client. Another related possibility is to have the thin client verify, through the host context agent, that the service is indeed running and hasn't died unexpectedly.

The GUI may provide an appropriate user interface for device scanning functionality. The user may be able to initiate a device scan for all hosts, for all hosts in a cluster, or for an individual host. The user interface may indicate 1) that a device scan is running for a particular host and 2) when a device scan completes.

It is believed that the method for improved host context access in storage-array-centric storage management interface of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A computer system, comprising:
a thin client;
a host context agent; and
a storage array, the storage array and the host context agent providing information to the thin client to be displayed on a graphical user interface of the thin client.

2. The computer system of claim 1, the host context agent having a control capability and comprising a framework for executing code on a corresponding host computer in which the code pushes context information to the storage array from the corresponding host computer and allows information to be pulled out of the corresponding host computer by the thin client.

3. The computer system of claim 2, wherein the context information includes topology and host type information.

4. The computer system of claim 1, the host context agent comprising an interface for plugging in host-dependent functions for information gathering and control on a corresponding host computer where a frame work for executing code is running.

5. The computer system of claim 1, the host context agent having plug-in functionality.

6. The computer system of claim 1, the host context agent comprising a framework for executing code on a corresponding host computer in which the code pushes context information to the storage array from the corresponding host computer and allows context information to be pulled out of the corresponding host computer by the thin client wherein the context information includes topology and host type information, having an interface for plugging in host-dependent functions for information gathering and control on a corresponding host computer where the frame work for executing code is running, and having plug-in functionality.

7. The computer system of claim 6, wherein mapping topology defining ports to hosts are stored in the storage array.

8. The computer system of claim 1, wherein topology acquisition is automated.

9. The computer system of claim 2, wherein the context information includes host cluster membership.

10. The computer system of claim 2, wherein the control capability includes device registration.

11. The computer system of claim 2, wherein the control capability includes management of services.

12. The computer system of claim 2, wherein the control capability includes device scanning.

13. A recording medium readable by a computer in which a program is stored, the program for transmitting printing information from an information processing apparatus to an external apparatus comprising the steps of:
generating and sending a command for a host context information to a host computer having the host context information; and
generating and second a command to a storage array for host context information.

14. The recording medium of claim 13, further comprising receiving the host context information from the storage array.

15. The recording medium of claim 14, further comprising displaying the host context information on a graphical user interface.

16. The recording medium of claim 15, the computer program at least primarily written in the JAVA language.

17. The recording medium of claim 15, the computer program interfacing with host context agent framework that uses plug ins.

18. The recording medium of claim 17, the host context agent framework being a Remote Procedure Call (RPC) server and the plug-ins being RPC procedures.

19. A method for host context access in storage array centric storage management interface, comprising:
making a request for host context data on a thin client;
generating and transmitting a provide first host context data command to multiple host computers;
generating and transmitting a provide second host context data command to a storage array.

20. The method of claim 19, further comprising generating a first host context data transfer from the host computers to the storage array upon receipt of the first host context data command.

21. The method of claim 20, further comprising updating the second host context data based on the first host context data.

22. The method of claim 21, further comprising transmitting the second host context data to the thin client.

23. The method of claim 22, further comprising displaying the second host context data.

24. The method of claim 23, the method being implemented on a host context agent framework that uses plug ins.

25. The method of claim 24, the host context agent framework being a Remote Procedure Call (RPC) server and the plug-ins being RPC procedures.

26. The method of claim 23, the method employing Java's Remote Method Invocation as the method for thin-client-to-host communication.
